(19) United States
(12) Patent Application Publication
(10) Pub. No.: US 2025/0128430 A1
(43) Pub. Date: Apr. 24, 2025

(54) MULTIFUNCTIONAL SOFT GRIPPER DEVICE

(71) Applicant: PUSAN NATIONAL UNIVERSITY INDUSTRY-UNIVERSITY COOPERATION FOUNDATION, Busan (KR)

(72) Inventors: Jung Han Kwon, Busan (KR); Jeong Min Shin, Busan (KR); Donghoon Son, Busan (KR); Seok Young Ahn, Busan (KR); Min Seong Kim, Busan (KR)

(73) Assignee: PUSAN NATIONAL UNIVERSITY INDUSTRY-UNIVERSITY COOPERATION FOUNDATION, Busan (KR)

(21) Appl. No.: 18/902,986

(22) Filed: Oct. 1, 2024

(30) Foreign Application Priority Data
Oct. 20, 2023 (KR) 10-2023-0141213

(51) Int. Cl. B25J 15/00; B25J 15/06; B25J 15/12

(52) U.S. Cl. CPC B25J 15/0052; B25J 15/0608; B25J 15/0683; B25J 15/12

(57) ABSTRACT

A multifunctional soft gripper device includes: a body unit which is moved depending on the position of a target object; a grip unit which includes a main body mounted below the body unit, a cup-shaped suction gripper provided on a lower end of the outer surface of the main body, a protrusion gripper having a plurality of small protrusions and provided on a lower portion of the outer surface thereof, and a finger gripper provided on an upper portion of the outer surface thereof; and an actuation unit mounted within the main body and the grip unit, which operates to move vertically, performing gripping motions with one of the suction gripper, protrusion gripper, or finger gripper based on the target object by operating the actuation unit in an optimal operation mode.

### CROSS-REFERENCE TO PRIOR APPLICATION

This Application claims priority to Korean Patent Application No. 10-2023-0141213 (filed on Oct. 20, 2023), which is hereby incorporated by reference in its entirety.

### BACKGROUND

The present invention relates to a multifunctional soft gripper device capable of gripping and moving target objects.

A soft gripper, which is made of a flexible material, is utilized to stably grasp and manipulate various objects, and is suitable for handling sensitive objects such as food. Using soft materials to grip objects reduces the likelihood of damage to the objects, thereby enhancing safety. Additionally, the flexible structure of the soft gripper can adapt to the shape of objects, transforming the shape of the gripper to securely grip the objects.

Recently, various designs and operation mechanisms of soft grippers, such as grippers utilizing pneumatics or vacuums, or grippers utilizing wires, have been proposed. However, there are still limitations in range of objects that the grippers can grip. For instance, “Angle-adjustable vacuum-gripper device” disclosed in Korean Patent No. 10-0926534 is a vacuum suction cup-shaped gripper which is effective for gripping flat objects, but is not suitable for objects like bolts or nuts.

Meanwhile, “Soft gripper unit and soft robot device including the same” disclosed in Korean Patent No. 10-2133497 includes a finger-shaped soft gripper which can grip objects like bolts and nuts, but has a limitation in gripping flat objects. As described above, soft grippers have different forms according to the shapes of objects, so must be specifically tailored to optimally grip objects.

In the automation industry, a variety of gripper designs are often modularized to grip different types of objects. The grippers can be interchangeably used in a tool changer format to flexibly respond to tasks. However, when changing the gripper types, a user must pause operations and requires time to exchange the grippers. In addition, setting up multiple gripper operation systems involves extra costs and space, posing a problem with high initial installation costs.

### RELATED ART

Patent Document 1: Korean Patent No. 10-0926534

Patent Document 2: Korean Patent No. 10-2133497

### SUMMARY

Accordingly, the present invention has been made to solve the above-mentioned problems occurring in the prior arts, and it is an objective of the present invention to provide a multifunctional soft gripper device, which selects a gripper shape suitable for target objects to perform a gripping motion without the need for tool changing, thereby being usefully utilized in various fields and effectively gripping various objects. The present invention is not limited to the technical objective, and further technical objectives may be derived from the description below.

To accomplish the above object, according to the present invention, there is provided a multifunctional soft gripper device including: a body unit which is moved depending on the position of a target object; a grip unit which includes a main body mounted below the body unit, a cup-shaped suction gripper provided on a lower end of the outer surface of the main body, a protrusion gripper having a plurality of small protrusions and provided on a lower portion of the outer surface thereof, and a finger gripper provided on an upper portion of the outer surface thereof; and an actuation unit mounted within the main body and the grip unit, which operates to move vertically, performing gripping motions with one of the suction gripper, protrusion gripper, or finger gripper based on the target object by operating the actuation unit in an optimal operation mode.

Moreover, the actuation unit includes an actuation bar vertically arranged in a long bar shape and installed such that a lower end is inserted into the upper surface of the suction gripper and an upper end is movable inside the body unit, and the operation of the grip unit is changed according to the vertical movement distance of the actuation bar.

Furthermore, the grip unit is made of a flexible material and is integrally formed at the front. When the actuation bar of the actuation unit moves upward, a lower end portion of the grip unit is rolled up inward, and when the actuation bar moves downward, the lower end portion of the grip unit unfolds downward internally.

Furthermore, the grip unit further includes a magnetic body which is made of a magnetic material, mounted at a lower end of the actuation bar, and spaced apart from the upper surface of the suction gripper. When the actuation bar moves downward, an upper portion of the suction gripper is bucked, such that the magnetic body comes into close contact with the suction gripper and is attached to the target object by magnetic force.

Additionally, the suction gripper includes: a suction face which is arranged at a lower portion thereof, and is formed in a circular shape with a bottom side formed to be upwardly concave to form a suction space at the center; and a coupling face which extends from the top surface of the suction face, protrudes upward, and has a mounting groove formed at the center where the lower end of an actuation bar is inserted.

In addition, the protrusion gripper is arranged above the suction gripper to be spaced apart from the suction gripper, and has the plurality of small protrusions formed to get narrower toward the ends.

Furthermore, the finger gripper includes: a gripping face which has upper and lower surfaces, of which ends are spaced apart from each other and connected to the body unit and the other ends are in contact with each other; and a plurality of joint faces which stand upright between the upper and lower surfaces of the gripping face and are arranged to be spaced apart from each other.

According to the embodiment of the present invention with the aforementioned configuration, the multifunctional soft gripper device offers the following advantages.

The single multifunctional soft gripper device selects the gripper shape with excellent gripping performance according to target objects to perform the gripping motion without the need for tool changing, thereby being usefully utilized in various fields and effectively gripping various target objects.

Additionally, the multifunctional soft gripper device allows the use of various types of grippers according to the vertical movement distance by using the single linear motion actuation unit, thereby simplifying the configuration, enabling a compact size, facilitating ease of use, and increasing work efficiency.

Additionally, the multifunctional soft gripper device, by utilizing the single linear motion actuation unit, can use various types of grippers depending on the vertical movement distance, thereby simplifying the configuration, providing a compact size, being easy to use, and increasing work efficiency.

In addition, the multifunctional soft gripper device includes the gripping part made of a single flexible material through injection molding, thereby being mass-produced easily at low costs, being interchangeable, minimizing the risk of damaging the target objects during gripping, ensuring safe operations, and continuously maintaining the quality of the target objects.

### BRIEF DESCRIPTION OF THE DRAWINGS

FIG. 1 is a perspective view of a multifunctional soft gripper device according to an embodiment of the invention.

FIG. 2 is a sectional view of the multifunctional soft gripper device according to an embodiment of the invention.

FIG. 3 is a block diagram of a control unit of the multifunctional soft gripper device according to an embodiment of the invention.

FIG. 4 is a diagram illustrating an operational sequence for a suction gripper operation mode of the multifunctional soft gripper device according to an embodiment of the invention.

FIG. 5 is a diagram illustrating an operational sequence for a protrusion gripper operation mode of the multifunctional soft gripper device according to an embodiment of the invention.

FIG. 6 is a diagram illustrating an operational sequence for a finger gripper operation mode of the multifunctional soft gripper device according to an embodiment of the invention.

FIG. 7 is a diagram illustrating an operational sequence for a magnetic gripper operation mode of the multifunctional soft gripper device according to an embodiment of the invention.

### DETAILED DESCRIPTION

Hereinafter, embodiments of the present invention are described in detail with reference to the attached drawings so that those skilled in the art can readily implement the present invention. The present invention can be realized in various forms and is not limited to the structure or method described herein.

The embodiment of the present invention relates to a multifunctional soft gripper device, which selects a gripper shape suitable for target objects to perform a gripping motion without the need for tool changing, thereby being usefully utilized in various fields and effectively gripping various objects.

While conventional multifunctional grippers use multiple actuation units to achieve functionality, the multifunctional soft gripper device proposed in the present invention can realize various gripping functions with just a single actuation unit, thereby allowing for gripping of various objects with different shapes, weights, and textures.

In a nuclear power plant, a multifunctional soft gripper device can simply and safely grasp various types of debris such as bolts, nuts, and chips that have settled at the bottom of used nuclear fuel storage pools. Such a multifunctional soft gripper device can flexibly respond to the shape and size of the target objects, so can be utilized in various situations.

Moreover, the multifunctional soft gripper device can be applied even in fields that require operations in special environments. For example, when various operations must be performed in extreme conditions such as space or deep-sea, the multifunctional soft gripper device can be utilized. The gripper device can be attached to a robotic arm of a space exploration robot or a deep-sea exploration robot to enhance work efficiency.

Additionally, the multifunctional soft gripper device is made of a soft material to safely grip objects like food or ingredients that are susceptible to damage. Accordingly, the multifunctional soft gripper device can be highly useful in the food industry.

In addition, the multifunctional soft gripper device can also be used as a gripper for an endoscopic robot in the medical field. The endoscopic robot is used in medical areas requiring sensitive operations. The soft characteristics of the multifunctional soft gripper device can provide the advantage of precisely gripping objects and minimizing damage.

Therefore, the multifunctional soft gripper device of the present invention can support various gripping functions with a single device, offering innovative solutions across various fields.

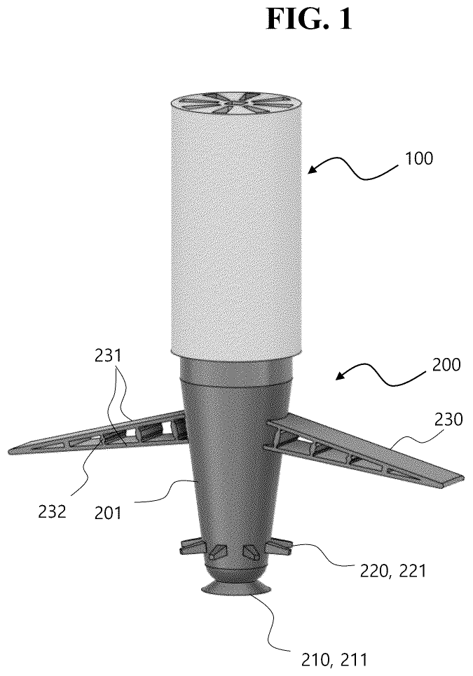

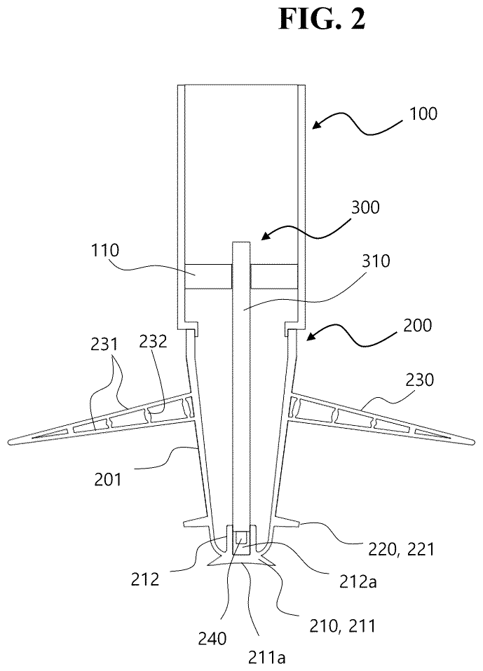

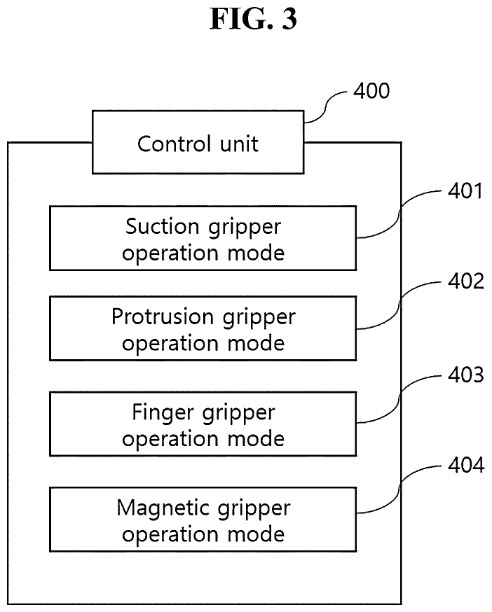

FIG. 1 is a perspective view of a multifunctional soft gripper device according to an embodiment of the invention, FIG. 2 is a sectional view of the multifunctional soft gripper device according to an embodiment of the invention, and FIG. 3 is a block diagram of a control unit of the multifunctional soft gripper device according to an embodiment of the invention.

Referring to FIGS. 1 to 3, the multifunctional soft gripper device of the present invention allows the selection of the gripper shape with excellent gripping performance according to target objects to perform the gripping motion. The multifunctional soft gripper device of the present invention include a body unit 100 connected to a robot's arm, a grip unit 200 which grips a target object 1, an actuation unit 300 which actuates the grip unit 200 in a selected operation mode, and a control unit 400 which controls the body unit 100 and the actuation unit 300.

The body unit 100 is configured to be connected to the robot's arm or a position-changeable device to be moved according to the position of the target object 1. This body unit 100 can be cylindrical and is configured such that an upper end thereof is connected to an end of the robot's arm. Additionally, the body unit 100 is formed to have an installation space for the actuation unit 300 formed therein so that the actuation unit 300 can be operated in the installation space, and the grip unit 200 mounted below the body unit 100.

The body unit 100 include a mount 110 protruding from the inner circumferential surface so that the actuation unit 300 can be installed inside the body unit 100. In this instance, the mount 110 is configured to enable the operation of the actuation unit 300 when the actuation unit 300 is installed. The body unit 100 moves to the location of the target object 1 by the movement of the robot's arm, and can approach or lift the target object 1 by a vertical movement.

The grip unit 200 uses a gripper suitable for the shape of the target object 1 to grip the target object 1 without causing damage or harm. In this instance, the grip unit 200 can have a main body 201 formed in an inverse cone shape, and various types of grippers can be equipped on the outer surface of the main body 201. Furthermore, the grip unit 200 is made of a flexible material and can be integrally formed by injection molding, thereby making it easy and inexpensive for mass production and allowing for replacement.

The main body 201 of the grip unit 200 is mounted to a lower portion of the body unit 100, and various types of grippers can be formed on the outer surface of the main body 201. Specifically, the grip unit 200 can include: a cup-shaped suction gripper 210 at a lower end of the outer surface thereof; a protrusion gripper 220 having a plurality of small protrusions 221 formed at a lower portion of the outer surface thereof; and a finger gripper 230 mounted at an upper portion of the outer surface thereof. The lower end of the grip unit 200 is mounted to the actuation unit 300 to perform the gripping motion and the releasing motion of the gripper depending on the operation of the actuation unit 300.

The suction gripper 210 is positioned at the bottom of the main body 201, and has a concave bottom surface to have a structure capable of sucking when the suction gripper 210 gets in contact with the surface of the target object 1. Structurally, the suction gripper 210 can include a suction face 211 and a coupling face 212. The suction face 211 is placed at a lower portion of the suction gripper 210, and is formed in a circular shape with a bottom side formed to be upwardly concave to form a suction space 211a at the center. The coupling face 212 extends from the top surface of the suction face 211, protrudes upward, and has a mounting groove 212a formed at the center where the lower end of an actuation bar 310 of the actuation unit 300 is inserted.

In this instance, when the body unit 100 descends, the suction gripper 210 comes into contact with the upper surface of the target object 1, and a vacuum is created by the suction space 211a to be sucked. The suction gripper 210 can lift the gripped target object 1 and move to a set position by the lifting motion of the body unit 100. Additionally, when the actuation bar 310 of the actuation unit 300 moves upward, the suction gripper 210 rolls inward and upward, causing the suction face 211 to be detached from the surface of the target object 1 to release the gripping motion, such that the target object 1 falls. As described above, the suction gripper 210 is preferably used when gripping objects 1 with flat surfaces.

The protrusion gripper 220 is positioned below the main body 201 and formed above the suction gripper 210 to be spaced apart from the suction gripper 210, and has a plurality of small protrusions 221 formed along the outer circumferential surface thereof. The protrusion gripper 220 has a structure to grasp the target object 1 while the plurality of small protrusions 221 wrap the outer circumferential surface of the target object 1. In this instance, the plurality of small protrusions 221 are arranged at regular intervals in a circular form, formed to be gradually thinner toward the end to stably wrap around the outer surface of the target object 1.

The protrusion gripper 220 is used in a state in which the suction gripper 210 rolls inward and is positioned at the bottom by the lifting motion of the actuation unit 300. The protrusion gripper 220 comes into contact with the outer circumferential surface of the target object 1 as the actuation bar 310 of the actuation unit 300 moves upward. In addition, the protrusion gripper 220 can be lifted to a set position while gripping the target object 1 by the actuation bar 310 moved upward to a higher position.

Moreover, when the actuation bar 310 moves downward, the protrusion gripper 220 makes the suction gripper 210 spread downward, such that the target object 1 falls down. As described above, the protrusion gripper 220 performs the gripping motion and the releasing motion by the lifting and lowering motions of the actuation unit 300, and is preferably used for gripping spherical or small-sized target objects 1.

The finger gripper 230 is located on an upper portion of the main body 201, is spaced above the protrusion gripper 220, has a plurality of individual fingers formed on the outer circumferential surface. The finger gripper 230 has a structure that allows the plurality of individual fingers to grip the target object 1 by wrapping around the outer surface of the target object 1. For instance, the finger gripper 230 can be structured with two individual fingers arranged symmetrically to face each other, thereby gripping the target object 1 at both sides.

In another example, the finger gripper 230 can have four individual fingers arranged in a cross pattern, symmetrically positioned both front-to-back and side-to-side, to stably grip the outer surface of the target object 1. In this instance, the finger gripper 230 can be used to grip spherical or larger target objects 1.

In another example, the finger gripper 230 can be structured with four individual fingers arranged in two rows facing each other, to grip the target object 1 in a symmetrically front-to-back arrangement. Here, the finger gripper 230 used to grip long target objects 1.

Specifically, the finger gripper 230 can include a gripping face 231 and a plurality of joint faces 232. The gripping face 231 has upper and lower surfaces, of which ends are spaced apart from each other and connected to the body unit and the other ends are in contact with each other. The plurality of joint faces 232 stand upright between the upper and lower surfaces of the gripping face 231, and are arranged to be spaced apart.

The finger gripper 230 is used in the state in which the suction gripper 210 and the protrusion gripper 220 are rolled inward by the lifting motion of the actuation unit 300 and the finger gripper 230 is located at the bottom and spread on both sides. Furthermore, the finger gripper 230 comes into contact with the outer circumferential surface of the target object 1 while the actuation bar 310 of the actuation unit 300 moves upward. Moreover, the finger gripper 230 can be lifted to a set position while gripping the target object 1 by the actuation bar 310 moved upward to a higher position.

Furthermore, the finger gripper 230 spreads ambilaterally as the actuation bar 310 moves downward, such that the target object 1 falls down. Thus, the finger gripper 230 can perform gripping and releasing motions through the lifting and lowering motions of the actuation unit 300, and is preferably used for gripping relatively larger spherical or large target objects 1 compared to those gripped by the protrusion gripper 220.

The grip unit 200 is made of a flexible material and has the whole surface formed integrally, allows the lower end of the grip unit 200 to roll up inward or unfold downward according to an operation direction of the actuation unit 300, thereby enabling the selection and use of one among various types of grippers.

Additionally, the grip unit 200 can further include a magnetic body 240 with magnetic force installed at a lower end of the actuation bar 310 of the actuation unit 300. In this instance, the magnetic body 240 can act as a gripper and be used for target objects 1 that can be attached by magnetic force. The magnetic body 240 is mounted at the bottom of the actuation bar 310, and is installed to be spaced within the mounting groove 212a of the suction gripper 210.

The magnetic body 240 approaches the surface of the target object 1 by the downward movement of the body unit 100, so the suction gripper 210 comes into close contact with the target object 1. Furthermore, the magnetic body 240 is in contact with the suction gripper 210 while the coupling surface, which is an upper portion of the suction gripper 210, buckles by the downward movement of the actuation bar 310. In this instance, the magnetic body 240 attaches to the target object 1 by magnetic force, and the target object 1 is lifted and moved up to a set position by the upward movement of the body unit 100.

The magnetic body 240 moves away from the upper portion of the suction gripper 210 as the actuation bar 310 moves upward, so the target object 1 and the magnetic body 240 are separated from each other such that the target object 1 falls down. As described above, the protrusion gripper 220 can perform gripping and releasing motions through the lifting and lowering motions of the actuation unit 300, and is preferably used for gripping spherical or small-sized target objects 1.

The actuation unit 300 is to select and operate any one of various types of grippers, and allows the gripping and releasing motions of the gripper. The actuation unit 300 is mounted within the body unit 100 and the grip unit 200, and can operate to vertically move within the body unit 100. As described above, the actuation unit 300 operates in the optimal operation mode according to the target object 1, and performs the gripping motion by any one among the suction gripper 210, the protrusion gripper 220, and the finger gripper 230.

The actuation bar 310 is vertically arranged in an long bar shape inside the actuation unit 300, and installed such that a lower end is inserted into the upper surface of the suction gripper 210 and an upper end is movable inside the body unit 100. In this instance, the actuation unit 300 changes the operation of the grip unit 200 according to the vertical movement distance of the actuation bar 310. Specifically, when the actuation bar 310 of the actuation unit 300 moves upward, the lower end of the grip unit 200 rolls inward and upward. When the actuation bar 310 moves downward, the lower end of the grip unit 200 unfolds and moves downward.

For example, the actuation unit 300 include a lead screw, which rotates in a longitudinal direction when a motor converts electrical energy into mechanical rotation. In this instance, as the lead screw rotates, the actuation bar 310 mounted on the outer circumferential surface ascends and moves, and when the mechanical rotation moves in the opposite direction, the actuation bar 310 descends and moves.

Alternatively, the actuation unit 300 include guide rails and a slider, which can move vertically. The guide rails are installed on both sides of the inner wall of the body unit 100 and can have vertically long guide grooves. Additionally, the slider is placed between the guide rails, is mounted on the actuation bar 310, and can slide up and down along the guide grooves. In this instance, the actuation bar 310 is connected to the slider, and moves the slider by pneumatic power to move the slider vertically.

Referring to FIG. 3, the control unit 400 controls the operation of the body unit 100 and the actuation unit 300. The control unit 400 can control the operation of the robot's arm to adjust the position movement of the body unit 100, and can control the lifting and lowering and the movement distance of the actuation unit 300. As described above, the control unit 400 can control to execute a suction gripper operation mode 401, a protrusion gripper operation mode 402, a finger gripper operation mode 403, and a magnetic gripper operation mode 404 according to the operations of the body unit 100 and the actuation unit 300.

The control unit 400 controls the actuation bar 310 of the actuation unit 300 to execute the operation modes stage by stage according to the vertical movement distance, and the stages can be classified from stage -1 to stage 6. Hereinafter, the operation modes by stages according to the vertical movement distance will be described. Stage 0 indicates that the actuation bar 310 is not moved from an initial installation position, and the movement distance is increased as the stages go higher from stage 1 to stage 6. Additionally, stage -1 indicates that the actuation bar 310 is moved downward from the initial installation position.

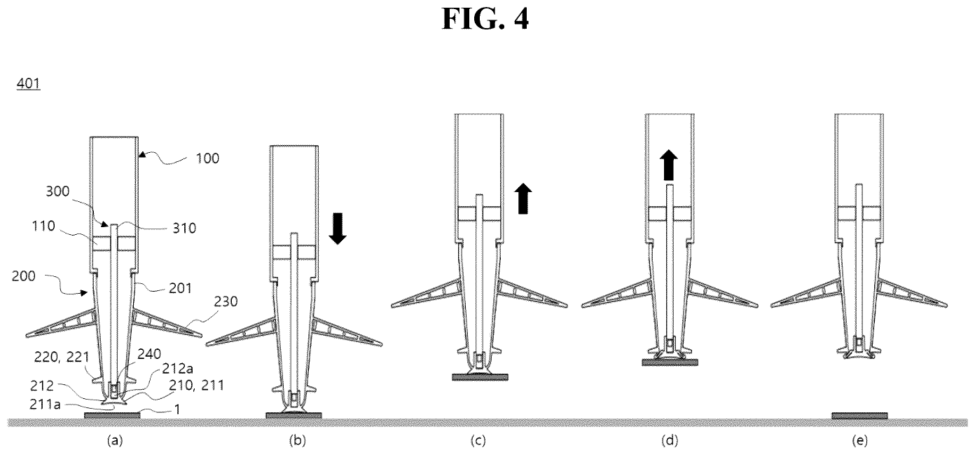

FIG. 4 is a diagram illustrating an operational sequence for the suction gripper operation mode of the multifunctional soft gripper device according to an embodiment of the invention. As illustrated in FIG. 4, the suction gripper operation mode 401 is a mode to perform the sucking motion of sucking the target object 1 by the suction gripper 210 and the releasing motion of releasing the sucked target object 1. Referring to FIGS. 4(a) to 4(e), the execution sequence of the suction gripper operation mode 401 will be described.

First, as illustrated in FIG. 4(a), the actuation bar 310 of the actuation unit 300 is positioned at stage 0, and the body unit 100 is moved to be positioned above the target object 1. Thereafter, as illustrated in FIG. 4(b), the body unit 100 descends toward the target object 1, so that the target object 1 is sucked in the state in which the suction gripper 210 is in close contact with the target object 1.

Subsequently, as illustrated in FIG. 4(c), the body unit 100 moves upward to the set position while the suction gripper 210 maintains the suction state. Next, as illustrated in FIG. 4(d), the actuation bar 310 moves upward to stage 1, causing the suction gripper 210 to partially roll inward. Thereafter, as illustrated in FIG. 4(e), the suction gripper 210 pushes the target object 1 away to release the gripping motion.

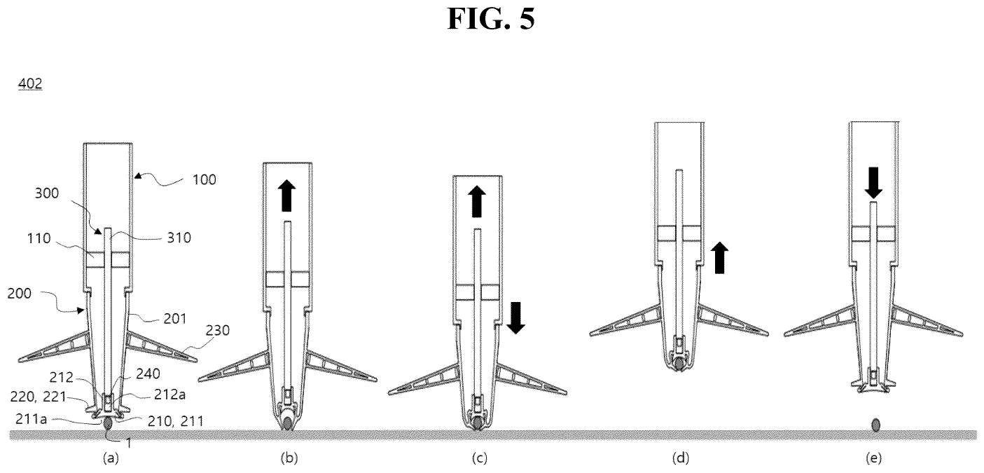

FIG. 5 is a diagram illustrating an operational sequence for the protrusion gripper operation mode of the multifunctional soft gripper device according to an embodiment of the invention. As illustrated in FIG. 5, the protrusion gripper operation mode 402 is a mode to perform the gripping motion of gripping the target object 1 by the protrusion gripper 220 and the releasing motion of releasing the gripped target object 1. Referring to FIGS. 5(a) to 5(e), the execution sequence of the protrusion gripper operation mode 402 will be described.

First, as illustrated in FIG. 5(a), the actuation bar 310 of the actuation unit 300 is positioned at stage 1, and the protrusion gripper 220 is moved to be positioned above the target object 1 in a state in which the suction gripper 210 is partially rolled inward and upward. Next, as illustrated in FIG. 5(b), the actuation bar 310 moves to stage 2, the protrusion gripper 220 is located at the bottom and the end of the protrusion gripper 220 wraps the outer surface of the target object 1.

Next, as illustrated in FIG. 5(c), the actuation bar 310 moves to stage 3, and the body unit 100 moves downward so that the target object 1 is gripped by the protrusion gripper 220. Next, as illustrated in FIG. 5(d), the body unit 100 moves upward, and the target object 1 is moved to the set position in a gripped state by the protrusion gripper 220. Thereafter, as illustrated in FIG. 5(e), the actuation bar 310 moves downward to stage 1, and the protrusion gripper 220 unfolds such that the target object 1 falls down, thereby releasing the gripping motion.

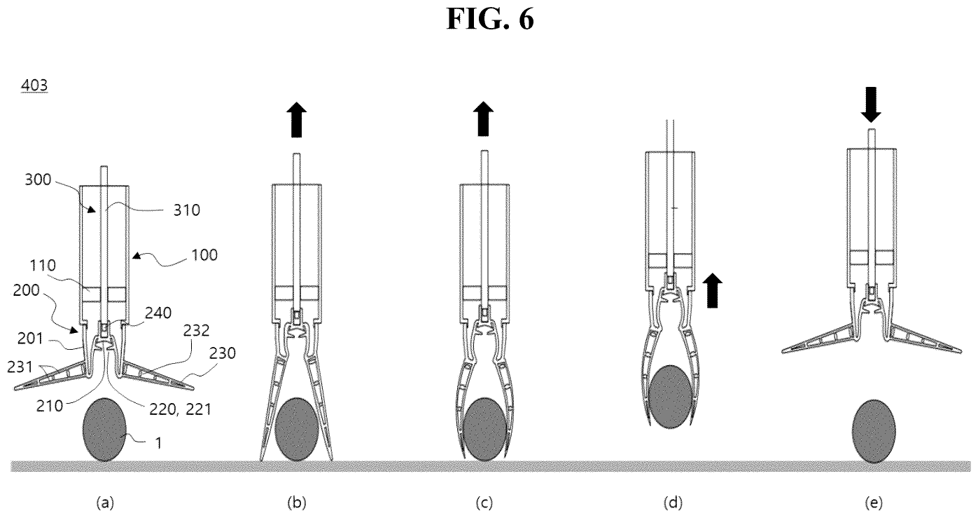

FIG. 6 is a diagram illustrating an operational sequence for the finger gripper operation mode of the multifunctional soft gripper device according to an embodiment of the invention. As illustrated in FIG. 6, the finger gripper operation mode 403 is a mode to perform the gripping motion of gripping the target object 1 by the finger gripper 230 and the releasing motion of releasing the gripped target object 1. Referring to FIGS. 6(a) to 6(e), the execution sequence of the finger gripper operation mode 403 will be described.

First, as illustrated in FIG. 6(a), the actuation bar 310 of the actuation unit 300 is positioned at stage 4, the finger gripper 230 unfolds in a state in which the suction gripper 210 and the protrusion gripper 220 are rolled inward and upward, and the body unit 100 moves to be positioned above the target object 1. Next, as illustrated in FIG. 6(b), when the actuation bar 310 moves to stage 5, the end of the finger gripper 230 directs the ground and wraps the outer surface of the target object 1.

Next, as illustrated in FIG. 6(c), when the actuation rod 310 moves to stage 6, the end of the finger gripper 230 comes into close contact with the target object 1 to grip the target object 1. Subsequently, as illustrated in FIG. 6(d), the main body 100 moves upward, and the target object 1 is moved to the set position in the gripped state by the finger gripper 230. Next, as illustrated in FIG. 6€, the actuation bar 310 moves downward to stage 4, and the finger gripper 230 unfolds such that the target object 1 falls down, thereby releasing the gripping motion.

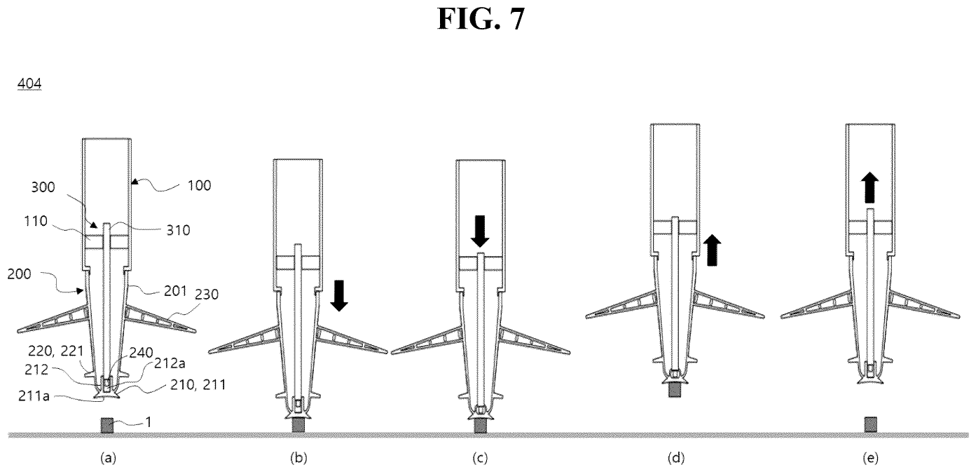

FIG. 7 is a diagram illustrating an operational sequence for the magnetic gripper operation mode of the multifunctional soft gripper device according to an embodiment of the invention. As illustrated in FIG. 7, the magnetic gripper operation mode 404 is a mode to perform the attaching motion of attaching the target object 1 by the magnetic body 240 and the releasing motion of releasing the attached target object 1. Referring to FIGS. 7(a) to 7(e), the execution sequence of the magnetic gripper operation mode 404 will be described.

First, as illustrated in FIG. 7(a), the actuation bar 310 of the actuation unit 300 is positioned at stage 0, and the main body 100 is moved to be located above the target object 1. Subsequently, as illustrated in FIG. 7(b), the main body 100 moves downward toward the target object 1, so that the suction gripper 210 comes into contact with the target object 1 and the magnetic body 240 is spaced apart from the suction gripper 210.

Thereafter, as illustrated in FIG. 7(c), the actuation bar 310 moves downward to stage -1, and the coupling face 212 of the suction gripper 210 wrapping the magnetic body 240 is buckled so that the magnetic body 240 is moved toward the suction face 211 of the suction gripper 210 to be attached to the target object 1.

Furthermore, as illustrated in FIG. 7(d), the main body 100 is moved upward, and the target object 1, which is attached to the suction gripper 210 by the magnetic body 240, is moved to the set position. Next, as illustrated in FIG. 7(e), the actuation bar 310 moves upward to stage 0, the coupling face 212 unfolds to the original state, so the magnetic body 240 is moved away from the suction face 211 of the suction gripper 210, thereby releasing the gripping motion from the target object 1.

The single multifunctional soft gripper device selects the gripper shape with excellent gripping performance according to target objects 1 to perform the gripping motion without the need for tool changing, thereby being usefully utilized in various fields and effectively gripping various target objects 1.

Additionally, the multifunctional soft gripper device allows the use of various types of grippers according to the vertical movement distance by using the single linear motion actuation unit 300, thereby simplifying the configuration, enabling a compact size, facilitating ease of use, and increasing work efficiency.

Additionally, the multifunctional soft gripper device, by utilizing the single linear motion actuation unit, can use various types of grippers depending on the vertical movement distance, thereby simplifying the configuration, providing a compact size, being easy to use, and increasing work efficiency.

In addition, the multifunctional soft gripper device includes the gripping part made of a single flexible material through injection molding, thereby being mass-produced easily at low costs, being interchangeable, minimizing the risk of damaging the target objects 1 during gripping, ensuring safe operations, and continuously maintaining the quality of the target objects 1.

Those skilled in the art will appreciate that the present invention can be implemented in a modified form without departing from the essential features of the present invention. Therefore, the disclosed embodiments should be considered in descriptive sense only and not for purposes of limitation. The scope of the present invention is shown n in the claims rather than the foregoing description, and all differences within the scope will be construed as being included in the present invention.

1. A multifunctional soft gripper device comprising:
a body unit which is moved depending on the position of a target object;
a grip unit which includes a main body mounted below the body unit, a cup-shaped suction gripper provided on a lower end of the outer surface of the main body, a protrusion gripper having a plurality of small protrusions and provided on a lower portion of the outer surface thereof, and a finger gripper provided on an upper portion of the outer surface thereof; and
an actuation unit mounted within the main body and the grip unit, which operates to move vertically, performing gripping motions with one of the suction gripper, protrusion gripper, or finger gripper based on the target object by operating the actuation unit in an optimal operation mode.

2. The multifunctional soft gripper device according to claim 1, wherein the actuation unit includes an actuation bar vertically arranged in a long bar shape and installed such that a lower end is inserted into the upper surface of the suction gripper and an upper end is movable inside the body unit, and
wherein the operation of the grip unit is changed according to the vertical movement distance of the actuation bar.

3. The multifunctional soft gripper device according to claim 2, wherein the grip unit is made of a flexible material and is integrally formed at the front,
wherein when the actuation bar of the actuation unit moves upward, a lower end portion of the grip unit is rolled up inward, and
wherein when the actuation bar moves downward, the lower end portion of the grip unit unfolds downward internally.

4. The multifunctional soft gripper device according to claim 2, wherein the grip unit further includes:
a magnetic body which is made of a magnetic material, mounted at a lower end of the actuation bar, and spaced apart from the upper surface of the suction gripper, and
wherein when the actuation bar moves downward, an upper portion of the suction gripper is bucked, such that the magnetic body comes into close contact with the suction gripper and is attached to the target object by magnetic force.

5. The multifunctional soft gripper device according to claim 2, wherein the suction gripper includes:
a suction face which is arranged at a lower portion thereof, and is formed in a circular shape with a bottom side formed to be upwardly concave to form a suction space at the center; and
a coupling face which extends from the top surface of the suction face, protrudes upward, and has a mounting groove formed at the center where the lower end of an actuation bar is inserted.

6. The multifunctional soft gripper device according to claim 1, wherein the protrusion gripper is arranged above the suction gripper to be spaced apart from the suction gripper, and has the plurality of small protrusions formed to get narrower toward the ends.

7. The multifunctional soft gripper device according to claim 1, wherein the finger gripper includes:
a gripping face which has upper and lower surfaces, of which ends are spaced apart from each other and connected to the body unit and the other ends are in contact with each other; and
a plurality of joint faces which stand upright between the upper and lower surfaces of the gripping face and are arranged to be spaced apart from each other.
